(19) United States
(12) Patent Application Publication
(10) Pub. No.: US 2006/0012285 A1
(43) Pub. Date: Jan. 19, 2006

(54) Fluorescent lamp with coldcathode of graphite and its manufacture method

(75) Inventors: Takahiro Matsumoto, Tokyo (JP); Hironori Hirama, Tokyo (JP)

Correspondence Address: FRISHAUF, HOLTZ, GOODMAN & CHICK, PC, 220 5TH AVE FL 16, NEW YORK, NY, 10001-7708, US

(73) Assignee: Stanley Electric Co., Ltd., Tokyo (JP)

(21) Appl. No.: 11/171,564

(22) Filed: Jun. 30, 2005

(30) Foreign Application Priority Data
Jul. 13, 2004 (JP) 2004-205685

(51) Int. Cl. H01J 1/62

(52) U.S. Cl. 313/491

(57) ABSTRACT

A cold cathode made of graphite is mounted at one end of a hollow tubular member. Concavities and convexities are formed on the surface of the cold cathode facing a center side of the tubular member. A fluorescent film is formed on the inner circumferential surface of the tubular member. An electron lead electrode for generating an electric field for pulling out electrons from the cold cathode is mounted on the tubular member. A fluorescent lamp is provided which uses the cold cathode capable of realizing good electron emission characteristics without an issue of tight adhesion between the cold cathode and a support substrate.

### CROSS REFERENCE TO RELATED APPLICATION

This application is based on and claims priority of Japanese Patent Application No. 2004-205685 filed on Jul. 13, 2004, the entire contents of which are incorporated herein by reference.

### BACKGROUND OF THE INVENTION

A) Field of the Invention

The present invention relates to a fluorescent lamp and its manufacture method, and more particularly to a fluorescent lamp in which electrons emitted from a cold cathode are made incident upon a fluorescent member to irradiate fluorescence, and to its manufacture method.

B) Description of the Related Art

Lamps for irradiating fluorescence are known, including a lamp in which ultraviolet rays generated by electric discharge in a mercury vapor are made incident upon a fluorescent member and a lamp in which ultraviolet rays generated by electric discharge in an inert gas having xenon as its main composition are made incident upon a fluorescent member.

The lamp utilizing electric discharge in a mercury vapor has a large brightness dependency upon temperature because the brightness depends upon a vapor pressure of mercury. The light amount lowers particularly at lower temperature. The light amount starts being lowered at an environment temperature over 60° C. A temperature range suitable for the lamp is therefore as narrow as from an ordinary temperature to about 60° C. It also has a long rise time of a light amount.

The lamp utilizing electric discharge in xenon has rarely a brightness dependency upon temperature and has a fast rise time of a light amount upon voltage application. However, its emission efficiency is lower than that of the mercury lamp. Further, since drive voltage is generally a pulse wave or rectangular wave, neighboring electronic apparatuses are much influenced. If this lamp is applied as back light of a liquid crystal display device of a vehicle mount navigation system, noises become a large issue.

Japanese Patent Laid-open Publication No. HEI-11-329312 discloses a fluorescent display device in which electrons emitted from a cold cathode are made incident upon a fluorescent member to irradiate fluorescence.

A typical example of an electric field emission type cold cathode device is a Spindt type cold cathode device proposed by C. A. Spindt, et. al. The Spindt type cold cathode device uses as a cold cathode a fine conical metal projection made of molybdenum. However, it is difficult to form a fine conical metal projection at good shape reproductivity, resulting in a low manufacture yield.

Cold cathode devices using carbon nanotubes are disclosed in Japanese Patent Laid-open Publications No. HEI-11-329312, No. 2003-86080, No. 2003-86079 and No. HEI-10-149760. In these cold cathode devices, carbon nanotubes or the like formed on a support substrate are used as the cold cathode. A section of prior art of the Japanese Patent Laid-open Publication No. HEI-11-329312 discloses the technologies of using as a cold cathode a diamond-like carbon (DLC) thin film or a diamond thin film formed on a support substrate.

The structure that carbon nanotubes or the like are formed on a support substrate cannot obtain sufficient tight adhesion between the support substrate and carbon nanotubes or the like. Further, a voltage drop at an interface between a cathode electrode and a cold cathode becomes a reason of deterioration (current saturation) of electron emission characteristics. Still further, since current concentrates upon the interface, destruction or the like of the cold cathode is likely to occur.

### SUMMARY OF THE INVENTION

An object of the present invention is to provide a fluorescent lamp using a cold cathode capable of realizing good electron emission characteristics and posing no issue of tight adhesion between the cold cathode and a support substrate.

Another object of the present invention is to provide a manufacture method for the fluorescent lamp described above.

According to one aspect of the present invention, there is provided a fluorescent lamp comprising: a hollow tubular member; a cold cathode made of graphite and mounted at one end of the tubular member, the cold cathode being formed with concavities and convexities on a surface facing a center side of the tubular member; a fluorescent film formed on an inner circumferential surface of the tubular member; and an electron lead electrode for generating an electric field for pulling out electrons from the cold cathode.

According to another aspect of the present invention, there is provided a fluorescent lamp comprising: a hollow tubular member; a fluorescent film formed on a partial inner circumferential surface of the tubular member extending in an axial direction; a cold cathode made of graphite and disposed at a position facing the fluorescent film in an inner space of the tubular member, the cold cathode being formed with concavities and convexities on a surface facing the fluorescent film; and an electron lead electrode for generating an electric field for pulling out electrons from the cold cathode.

According to still another aspect of the present invention, there is provided a manufacture method for a fluorescent lamp comprising steps of: forming a fluorescent film on a first surface of a first member, the first surface being defined on a surface of the first member and having an elongated shape; assembling a cold cathode made of graphite on a second surface of a second member, the second surface being defined on a surface of the second member and having an elongated shape, a surface of the cold cathode being formed with concavities and convexities and facing a side opposite to the second member; and disposing the first and second members with the first and second surfaces facing each other and spaced by a gap, closing sides and opposite ends to define a space surrounded by the first and second members, and evacuating the space.

According to still another aspect of the present invention, there is provided a manufacture method for a fluorescent lamp comprising steps of: forming a fluorescent film on an inner circumferential surface of a hollow tubular member which is open at least one end; removing the fluorescent film in an elongated area along a longitudinal direction of the inner circumferential surface of the tubular member; assembling a cold cathode made of graphite in an area where the fluorescent film was removed, a surface of the cold cathode being formed with concavities and convexities and facing the fluorescent film; and closing the open end of the tubular member and evacuating an inner space.

Good electron emission characteristics can be realized by using the cold cathode made of graphite and formed with concavities and convexities on the surface thereof.

### BRIEF DESCRIPTION OF THE DRAWINGS

FIG. 1A is a photograph of the surface of a graphite substrate before a hydrogen plasma process.

FIG. 1B is a photograph of the surface of the graphite substrate after the hydrogen plasma process.

FIG. 2 is a graph showing the measurement results of electron emission characteristics of a graphite substrate before (dotted line) and after (solid line) hydrogen plasma process.

FIG. 3 is a comparison graph of the electron emission characteristics between a cold cathode made of graphite and a conventional cold cathode.

FIG. 4 is a cross sectional view of a fluorescent lamp according to a first embodiment.

FIG. 5 is a cross sectional view of a fluorescent lamp according to a second embodiment.

FIGS. 6A and 6B are cross sectional views of a fluorescent lamp according to a third embodiment, and FIG. 6C is a cross sectional view of a modification of the fluorescent lamp.

FIGS. 7A and 7B are cross sectional views of a fluorescent lamp according to a fourth embodiment, and FIG. 7C is a cross sectional view of a modification of the fluorescent lamp.

FIGS. 8A and 8B are cross sectional views of a fluorescent lamp according to a fifth embodiment.

FIGS. 9A and 9B are cross sectional views of a fluorescent lamp according to a sixth embodiment.

### DESCRIPTION OF THE PREFERRED EMBODIMENTS

Description will be made on a manufacture method for a cold cathode made of graphite to be used with fluorescent lamps according to the embodiments of the present invention. Prepared is a substrate made of graphite and having a mirror surface. The surface of the substrate is exposed to hydrogen plasma. For example, this hydrogen plasma process can be made by using a microwave plasma etcher.

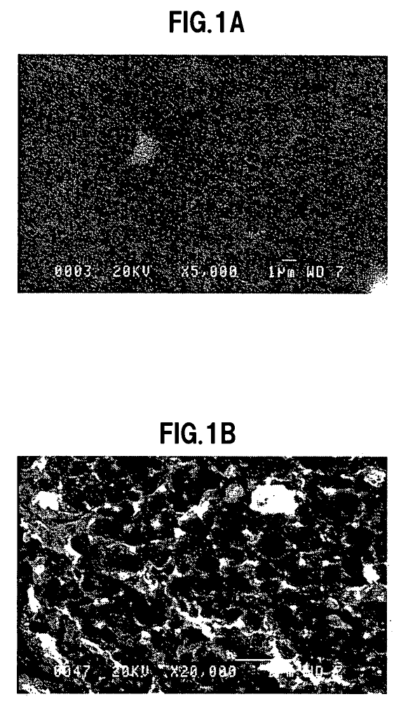

FIG. 1A shows a scanning type electron microscope (SEM) photograph showing the surface of a graphite substrate before a hydrogen plasma process, and FIG. 1B shows a SEM photograph showing the surface of the graphite substrate after the hydrogen plasma process. The graphite substrate shown in FIG. 1B was subjected to a hydrogen plasma process for 30 minutes under the conditions of an input RF power of 800 W, a pressure of about 1330 Pa (about 10 Torr) and a hydrogen flow rate of 80 sccm, by using a micro wave plasma etcher.

As shown in FIG. 1A, the substrate surface before the hydrogen plasma etching is almost flat. After the hydrogen plasma process, as shown in FIG. 1B, fine concavities and convexities are formed which have an in-plane size of about 0.5 μm. It can be considered that a roof-shaped convexity is formed at the border between adjacent concavities. It can be considered that the height of this roof-type convexity is not constant but the spine of the roof-type convexity undulates. It can be considered from these reasons that projections having a sharp top edge are dispersively distributed along the roof-type convexity.

As an electric field is applied to the surface of the graphite substrate formed with concavities and convexities, the electric field is concentrated upon the sharp top edges of the projections. It can therefore be considered that electrons are more likely to be emitted from the graphite substrate than from the mirror surface.

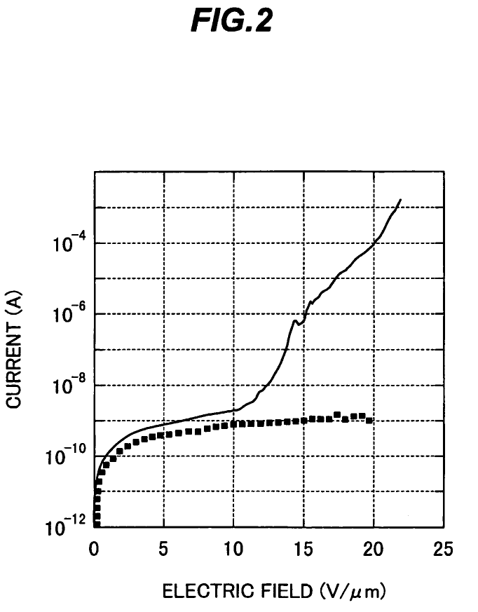

FIG. 2 shows the measurement results of electron emission characteristics of a graphite substrate. The abscissa represents an electric field formed on the surface of a graphite substrate in the unit of “V/μm”, and the ordinate represents a current by electrons emitted from the graphite substrate in the unit of “A”. A broken line in FIG. 2 indicates the measurement results of the graphite substrate before a hydrogen plasma process, and a solid line indicates the measurement results of the graphite substrate after the hydrogen plasma process.

It can be understood that electrons are hardly emitted from the graphite substrate having the mirror surface before the hydrogen plasma process. It can be understood that electrons are emitted in the surface electric field range over 10 V/μm, from the graphite substrate formed with concavities and convexities on the surface thereof by the hydrogen plasma process. It is therefore possible to use the graphite substrate subjected to the hydrogen plasma process as a cold cathode. A threshold value of electron emission is considered to be about 10 V/μm.

In the embodiment described above, projections are formed by exposing the surface of a graphite substrate to hydrogen plasma. The manufacture processes can therefore be simplified more than a Spindt type cold cathode formed by growing a number of projections on a support substrate. Projections formed by the hydrogen plasma process are essentially parts of the graphite substrate, posing no issue to be caused by a tight adhesion degree between projections and an underlying layer. Since the graphite substrate itself is a cathode electrode, there is no issue to be caused by contact resistance between projections and the cathode electrode. With the method described above, it is possible to manufacture a cold cathode which is not expensive, has a long lifetime and is stable.

The hydrogen plasma process may be performed under the conditions in the ranges of an input RF power of 100 to 1000 W, a pressure of 1.33×10² to 1.33×10⁴ Pa (1 to 100 Torr), a hydrogen flow rate of 5 to 100 sccm and a process time of 1 to 100 minutes. Good electron emission characteristics are obtained by performing the hydrogen plasma process under the conditions of these ranges. A height difference between concavities and convexities formed on the graphite substrate surface becomes large in some cases if a proper potential difference is applied between hydrogen plasma and a graphite substrate. With a large height difference between concavities and convexities, better electron emission characteristics are obtained.

In the above-described method, the hydrogen plasma process is performed by using a microwave plasma etcher. Other plasma etchers may also be used such as an electron cyclotron resonance (ECR) plasma system and a reactive ion etching (RIE) system. Gas for chemically etching graphite may be oxygen, CF₄ or the like in addition to hydrogen. Depending upon the process conditions, concavities and convexities are formed on the surface of a graphite substrate by both a chemical etching process and a physical sputtering process.

In the embodiment described above, although concavities and convexities are formed on the surface of a graphite substrate by using mainly the chemical etching process, they may be formed by using mainly the physical sputtering process. For example, argon (Ar) or nitrogen (N₂) may be used as sputtering gas. Concavities and convexities may be formed on the surface of a graphite substrate by a mechanical surface preparation such as sand blast. Concavities and convexities may also be formed by irradiating a pulse laser beam to the surface of a graphite substrate to damage the surface.

The mechanical surface preparation may be used in combination. For example, the mechanical surface preparation is performed to form concavities and convexities, and thereafter the chemical etching process or physical sputtering process is performed.

It is expected that the electron emission characteristics are improved by forming concavities and convexities on a graphite surface and thereafter irradiating a laser beam such as CO₂ laser, Nd:YAG laser and excimer laser. It is reported that the electron emission characteristics can be improved by irradiating a laser beam to a cold cathode using carbon nanotubes (e.g., J. S. Kim et. al., “Ultraviolet laser treatment of multiwallcarbon nanotubes grown at room temperature”, Appl. Phys. Lett. 82, 1607 (2003)).

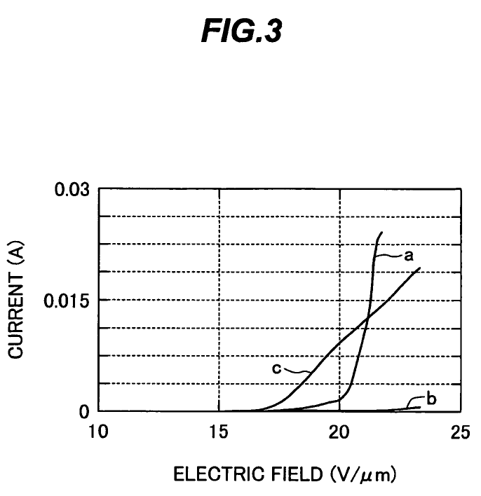

FIG. 3 is a comparison graph of the electron emission characteristics between a conventional cold cathode and a cold cathode made of graphite and formed by the above-described embodiment method. The abscissa represents an electric field on the surface of a cold cathode in the unit of “V/μm”, and the ordinate represents a current by electron emission in the unit of “A”. Solid lines a, b and c shown in FIG. 3 indicate the electron emission characteristics of a cold cathode made of graphite and formed by the above-described embodiment method, a cold cathode using graphite nanofibers (GNF) formed on an FeNi alloy substrate by thermal CVD, and a cold cathode using carbon nanotubes (CNT) formed on an FeNi alloy substrate by plasma CVD, respectively.

A slope of the graph of the cold cathode made of graphite and formed by the embodiment method is steeper than those of the graphs of the other two cold cathodes. This means that resistance components are small.

As described above, a good quality cold cathode can be formed by forming concavities and convexities on a graphite surface.

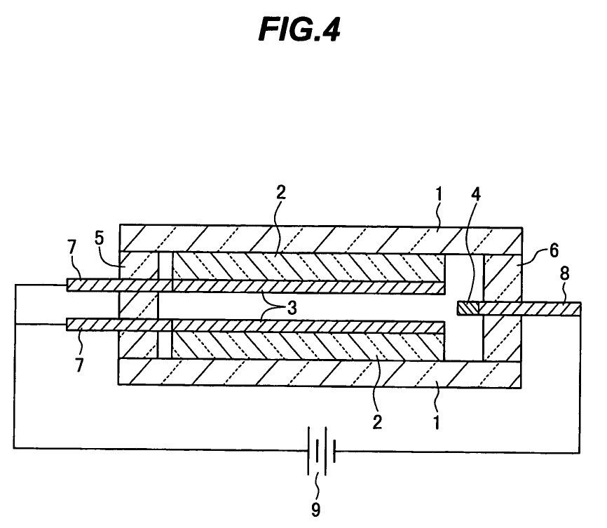

FIG. 4 is a cross sectional view of a fluorescent lamp according to the first embodiment. On an inner circumferential surface of a cylindrical glass tube 1, a fluorescent film 2 having a thickness of about 20 μm is formed. For example, the fluorescent film 2 is formed by melting fluorescence material formed by mixing white fluorescence materials Y₂O₃S:Tb and Y₂O₃:Eu in solvent, coating the fluorescence mixture on the inner circumferential surface of the glass tube 1 and drying it. On the surface of the fluorescent film 2, an electron lead electrode 3 is vapor-deposited, having a thickness of 100 to 200 nm and made of aluminum (Al).

Opposite ends of the glass tube 1 are closed by face glasses 5 and 6. The face glasses 5 and 6 are adhered to the glass tube 1 by low melting point frit glass. Two lead pins 7 are pierced through the face glass 5 and one lead pin 8 is pierced through the face glass 6. An air-tight space is defined in the glass tube 1, and this inner space is evacuated to a pressure of 1.3×10⁻³ Pa (1×10⁻⁵ Torr) or lower. The inner space can be maintained at a high vacuum during a long period by disposing a getter such as Ba and Ti in the inner space.

Ends of the lead pins 7 on the side of the inner space are connected to the electron lead electrodes 3. A cold cathode 4 is fixed to the end of the lead pin 8 on the side of the inner space. In this manner, the cold cathode 4 is disposed at one end portion of the inner space of the glass tube 1. The cold cathode 4 is made of graphite having concavities and convexities formed on the graphite surface, and fixed in such a posture as the surface formed with the concavities and convexities is directed toward the central area of the glass tube 1.

The anode of a d.c. power source 9 is connected to the electron lead electrodes 3 via the lead pins 7 and the cathode is connected to the cold cathode 4 via the lead pin 8.

As the intensity of an electric filed generated on the surface of the cold cathode 4 exceeds the threshold value, electrons are emitted from the cold cathode 4 and accelerated toward the electron lead electrodes 3. Electrons collided with the electron lead electrodes 3 pass through the electron lead electrodes and reach the fluorescent film 2. As a result, the fluorescent material of the fluorescent film 2 is excited and irradiates white fluorescence. Fluorescence generated in the fluorescent film 2 is emitted efficiently to an external, being reflected by the electron lead electrodes 3.

Materials other than Y₂O₃S:Tb and Y₂O₃:Eu may be used as fluorescent material. For example, if diamond, aluminum nitride (AlN), boron nitride (BN) or the like having good crystallinity is used as the fluorescent material, ultraviolet rays having a wavelength of 250 nm or shorter can be generated. In this case, it is necessary to use as the material of the glass tube 1, the material on which these fluorescent materials can be epitaxially grown and through which ultraviolet rays can transmit.

If the electron lead electrodes 3 are too thin, pin holes and the like are likely to be formed so that the reflection efficiency lowers. Conversely, if they are too thick, accelerated electrons are absorbed in the electron lead electrodes 3 and cannot reach the fluorescent film 2. For example, if the Al film is as thick as 4 μm, the transmittance is almost zero for electrons accelerated at an acceleration energy of 10 keV. By considering these conditions, it is preferable to set the thicknesses of the electron lead electrodes 3 to 100 to 200 nm as described earlier.

In the structure of the first embodiment, since the cold cathode 4 is disposed at one end portion of the glass tube 1, radiation amounts of electron beams are not uniform along a longitudinal direction. The uniformity of radiation amounts is likely to be lowered particularly if the glass tube 1 is made long and slender. In such a case, it is possible to suppress the uniformity from being lowered, by adjusting a voltage applied between the electron lead electrodes 3 and the cold cathode 4.

In the first embodiment, the fluorescent film 2 is formed on the inner circumferential surface of the glass tube 1, and the electron lead electrodes 3 are formed on the fluorescent film 2. Conversely, the electron lead electrodes 3 may be formed on the inner circumferential surface of the glass tube 1, and the fluorescent film 2 is formed on the electron lead electrodes 3. In this structure, the electron lead electrodes 3 are disposed between the glass tube 1 and fluorescent film 2.

It is necessary for this structure to form a window in the electron lead electrodes 3 and fluorescent film 2 in order to guide fluorescence generated in the fluorescent film 2 to an external. For example, in a cross section perpendicular to a center axis of the glass tube, an area cut with a sector having a central angle of 90° is used as the window where the electron lead electrodes 3 and fluorescent film 2 are not formed.

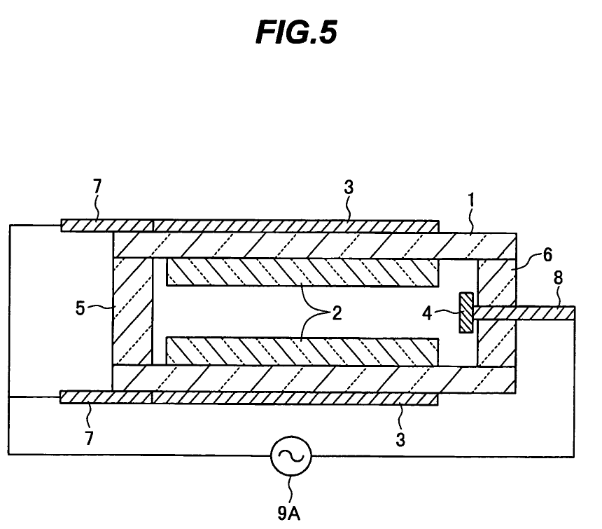

FIG. 5 is a cross sectional view of a fluorescent lamp according to the second embodiment. In the first embodiment, although the electron lead electrodes 3 are disposed inside the glass tube 1, in the second embodiment the electron lead electrodes 3 are vapor-deposited on the outer circumferential surface of the glass tube 1. In the first embodiment, although the d.c. voltage is applied between the cold cathode 4 and the electron lead electrodes 3, in the second embodiment, an a.c. power source 9A is connected between the cold cathode 4 via the lead pin 8 and the electron lead electrodes 3 via the lead pins 7. The other structures are similar to those of the fluorescent lamp of the first embodiment.

In the second embodiment, when the intensity of the electric field generated on the surface of the cold cathode 4 exceeds the threshold value, during the period while the potential of the electron lead electrodes 3 is higher than the potential of the cold cathode 4, electrons are emitted from the cold cathode. Fluorescence is therefore generated similar to the first embodiment. Generated fluorescence is irradiated to an external by passing through the electron lead electrodes 3. In order to efficiently irradiate fluorescence to the external, it is preferable that the electron lead electrodes 3 are made of transparent conductive material such as indium tin oxide (ITO) or are made to have a mesh shape.

If the electron lead electrodes 3 are disposed on the outer side of the glass tube 1 and the cold cathode 4 is grounded, electric discharge or leakage are likely to occur on the electron lead electrodes 3 side. In order to suppress electric discharge or leakage, it is preferable to ground the electron lead electrodes 3 side. The frequency of the a.c. power source is preferably set to 100 Hz to 10 MHz, by considering a relaxation time of fluorescent member, a capacitance of the fluorescent lamp, a flying time of electrons from the cold cathode 4 to the fluorescent film 2 and the like. According to the experiments made by the present inventors, even if a d.c. voltage is applied, light emission was observed at least ten minutes.

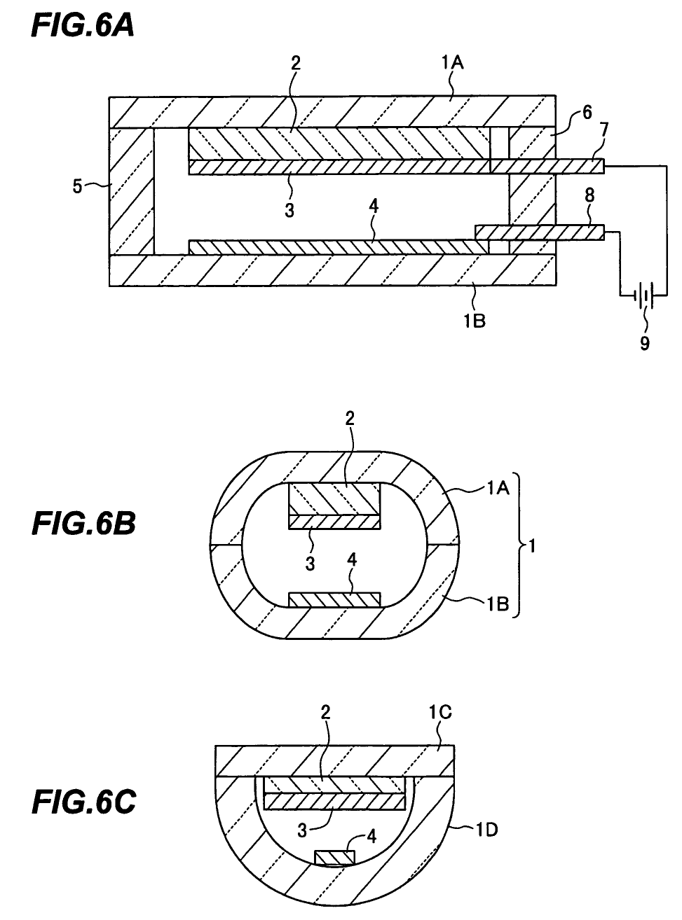

FIGS. 6A and 6B are cross sectional views of a fluorescent lamp according to the third embodiment. FIG. 6A shows a cross section parallel to the center axis of the fluorescent lamp, and FIG. 6B shows a vertical cross section.

On the inner surface of a cylindrical glass tube 1, a pair of flat areas is defined facing each other generally in parallel over the central axis. A fluorescent film 2 is formed in one flat area and an electron lead electrode 3 is formed on the fluorescent film 2. A cold cathode 4 made of graphite and having concavities and convexities formed on the surface thereof is fixed to the other flat area. The materials and thicknesses of the fluorescent film 2 and electron lead electrode 3 are the same as those of the fluorescent lamp of the first embodiment shown in FIG. 4.

Opposite ends of the glass tube 1 are closed by face glasses 5 and 6. Lead pins 7 and 8 are pierced through the face glass 6. The lead pin 7 is connected to the electron lead electrode 3 and the other lead pin 8 is connected to the cold cathode 4. A d.c. power source 9 is connected between the electron lead electrode 3 and cold cathode 4 via the lead pins 7 and 8, respectively. A d.c. voltage is applied in such a manner that the electron lead electrode 3 has a potential higher than that of the cold cathode 4. The d.c. voltage is, for example, 20 to 30 keV.

Next, description will be made on a manufacture method for the fluorescent lamp according to the third embodiment. The glass tube 1 is cut along a plane including the center axis and being parallel to the pair of flat areas to thereby separate it into glass members 1A and 1B. The fluorescent film 2 is formed in the flat area of the glass member 1A by coating or vapor deposition. The electron lead electrode 3 of Al is vapor-deposited on the surface of the fluorescent film 2. Since the cylindrical glass tube 1 is separated into two glass members 1A and 1B, the fluorescent film 2 and electron lead electrode 3 can be formed easily even if the glass tube 1 is long and slender.

The cold cathode 4 is fixed to the flat area of the other glass member 1B with adhesive or the like. In this case, the cold cathode 4 is fixed in such a manner that the surface of the cold cathode on which concavities and convexities are formed is faced toward the side opposite to the glass member 1B.

The glass members 1A and 1B are adhered with frit glass adhesive to recover the original shape of the glass tube 1. In this case, the pair of flat areas are disposed in parallel with a some distance therebetween, and the both sides are closed air-tightly. Opposite openings are closed with face glasses 5 and 6, and the inner space is evacuated. In order to evacuate the inner space, an air exhaust pipe is mounted beforehand through the glass tube 1, and after evacuation through the exhaust pipe, this pipe is cut and sealed.

A fluorescent lamp was manufactured, a length of the glass tube 1 was 200 mm, a distance between the pair of flat areas facing each other on the inner surface of the glass tube 1 was 5 mm, and a width of the fluorescent film 2 and electron lead electrode 3 was 5 mm. At a d.c. voltage of 20 keV, a current of about 10 mA flowed and fluorescence was generated. Namely, a consumption power was about 200 W.

FIG. 6C is a cross sectional view of a fluorescent lamp according to a modification of the third embodiment. In this modification, instead of the glass member 1A shown in FIG. 6B, a flat glass member 1C is used. Instead of the other glass member 1B, a semi-cylindrical glass member 1D is used by cutting a cylindrical tube along a flat plane including the center axis. Other glass members having various cross sectional shapes may also be used.

In the third embodiment shown in FIGS. 6A and 6B and the modification thereof shown in FIG. 6C, the order of the lamination of the fluorescent film 2 and electron lead electrode 3 may be reversed. Namely, the electron lead electrode may be disposed between the glass tube 1 and fluorescent film 2. In this case, fluorescence generated in the fluorescent film 2 is observed from the cold cathode 4 side. The size of the cold cathode 4 is preferably made small to the extent that the function of the cold cathode is not degraded.

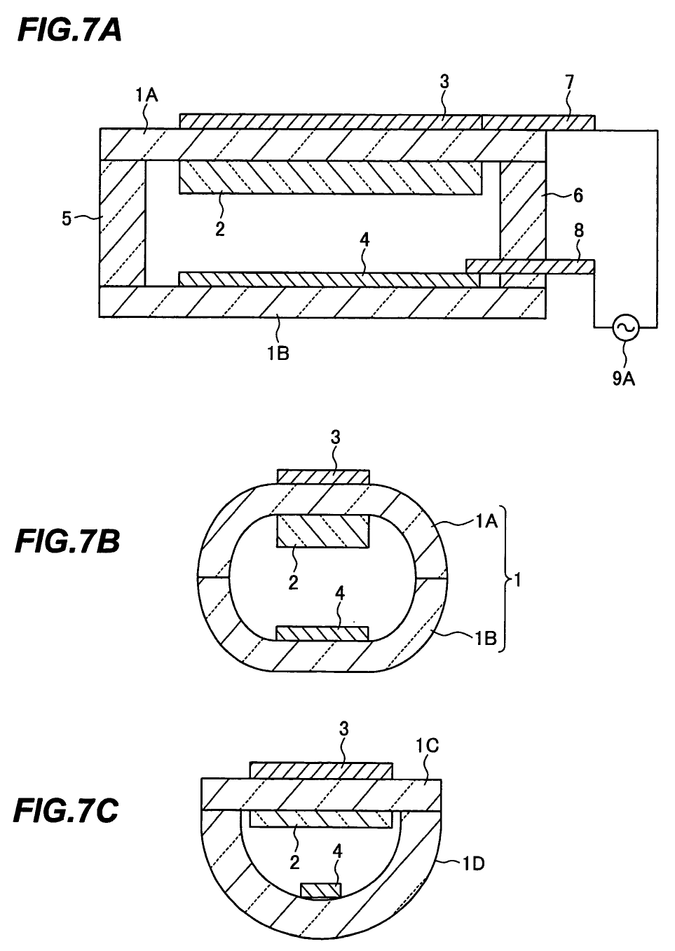

FIGS. 7A and 7B are cross sectional views of a fluorescent lamp according to the fourth embodiment. FIG. 7A shows a cross section parallel to the center axis of the fluorescent lamp, and FIG. 7B shows a vertical cross section.

In the third embodiment, although the electron lead electrode 3 is disposed in the glass tube 1, in the fourth embodiment, the electron lead electrode 3 is formed on the outer surface of the glass member 1A. Instead of the d.c. power source 9, an a.c. power source 9A is used. The other structures are similar to those of the fluorescent lamp of the third embodiment.

FIG. 7C is a cross sectional view of a fluorescent lamp according to a modification of the fourth embodiment. The fluorescent lamp according to the modification of the fourth embodiment has the structure that the electron lead electrode 3 of the fluorescent lamp according to the modification of the third embodiment shown in FIG. 6C is formed on the outer surface of the flat glass member 1C. The electron lead electrode 3 is made of transparent conductive material such as ITO or is made to have a mesh shape.

Even if the electron lead electrode 3 is formed outside the inner space in which the fluorescent film 2 and cold cathode 4 are disposed, fluorescence can be generated similar to the second embodiment shown in FIG. 5.

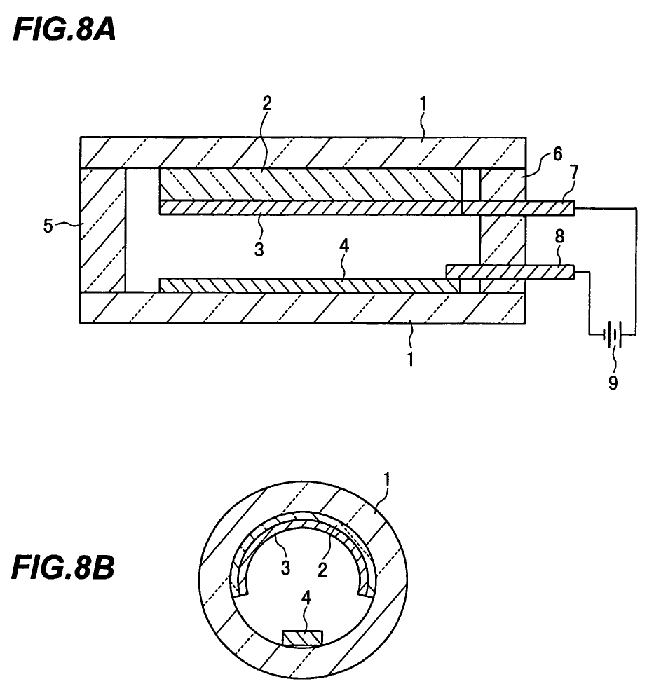

FIGS. 8A and 8B are cross sectional views of a fluorescent lamp according to the fifth embodiment. FIG. 8A shows a cross section parallel to the center axis of the fluorescent lamp, and FIG. 8B shows a vertical cross section.

A fluorescent film 2 is formed in a partial area, extending along an axial direction, of the inner surface of a cylindrical glass tube 1. An electron lead electrode 3 is formed on the surface of the fluorescent film 2. The fluorescent film 2 and electron lead electrode 3 are formed by coating a fluorescent member on the whole inner surface, vapor-depositing an aluminum film on the surface of the fluorescent member, and thereafter removing the films formed in a partial inner surface area mechanically, chemically or both.

An elongated cold cathode 4 made of graphite is inserted into the glass tube 1 and fixed to the exposed inner surface area of the glass tube 1. The cold cathode 4 is disposed facing the fluorescent film 2. The cold cathode 4 has concavities and convexities formed on the surface facing the fluorescent film 2.

Opposite ends of the glass tube 1 are closed with face glasses 5 and 6, and the inner space is evacuated. The structures of lead pins 7 and 8 and a power source 9 are the same as those of the fluorescent lamp of the third embodiment shown in FIGS. 6A and 6B. Fluorescence can be generated similar to the third embodiment.

In the fifth embodiment shown in FIGS. 8A and 8B, the order of the lamination of the fluorescent film 2 and electron lead electrode 3 may be reversed. Namely, the electron lead electrode 3 may be disposed between the glass tube 1 and fluorescent film 2. In this case, fluorescence generated in the fluorescent film 2 is observed from the cold cathode 4 side. The size of the cold cathode 4 is preferably made small to the extent that the function of the cold cathode is not degraded.

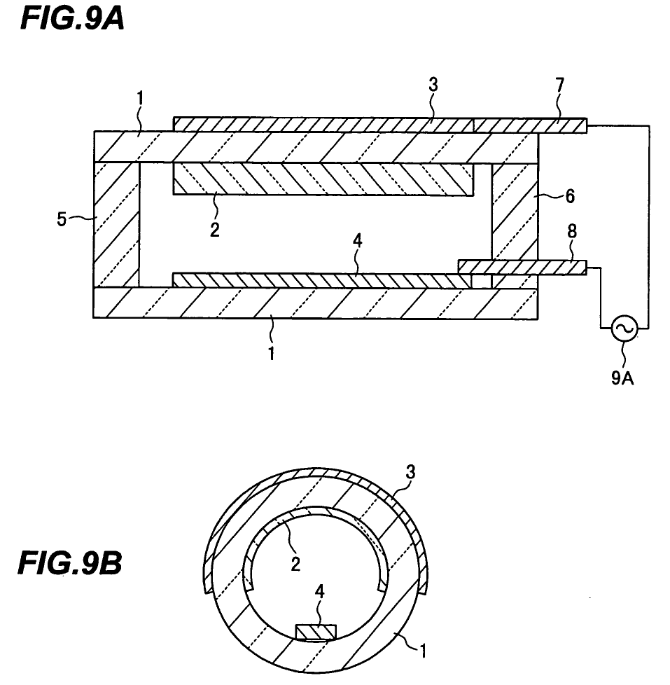

FIGS. 9A and 9B are cross sectional views of a fluorescent lamp according to the sixth embodiment. FIG. 9A shows a cross section parallel to the center axis of the fluorescent lamp, and FIG. 9B shows a vertical cross section. In the fifth embodiment shown in FIGS. 8A and 8B, although the electron lead electrode 3 is formed in the inner space of the glass tube 1, in the sixth embodiment the electron lead electrode 3 is formed on the outer circumferential surface of the glass tube 1. The area formed with the electron lead electrode 3 generally matches the area formed with the fluorescent film 2. The electron lead electrode 3 is made of transparent conductive material such as ITO or is made to have a mesh shape. Instead of the d.c., power source 9, an a.c. power source 9A is used. The other structures are the same as those of the fluorescent lamp of the fifth embodiment. Fluorescence can be generated similar to the fourth embodiment shown in FIGS. 7A and 7B.

The present invention has been described in connection with the preferred embodiments. The invention is not limited only to the above embodiments. It will be apparent to those skilled in the art that other various modifications, improvements, combinations, and the like can be made.

What we claim are:

1. A fluorescent lamp comprising:
a hollow tubular member;
a cold cathode made of graphite and mounted at one end of the tubular member, the cold cathode being formed with concavities and convexities on a surface facing a center side of the tubular member;
a fluorescent film formed on an inner circumferential surface of the tubular member; and
an electron lead electrode for generating an electric field for pulling out electrons from the cold cathode.

2. The fluorescent lamp according to claim 1, wherein the electron lead electrode is formed on a surface of the fluorescent film.

3. The fluorescent lamp according to claim 1, wherein the electron lead electrode is formed between the tubular member and the fluorescent film.

4. The fluorescent lamp according to claim 1, wherein the electron lead electrode is formed on an outer circumferential surface of the tubular member.

5. The fluorescent lamp according to claim 4, wherein the electron lead electrode is made of conductive material and has a mesh shape, or is made of conductive material through which fluorescence emitted from the fluorescent film is transmitted.

6. A fluorescent lamp comprising:
a hollow tubular member;
a fluorescent film formed on a partial inner circumferential surface of the tubular member extending in an axial direction;
a cold cathode made of graphite and disposed at a position facing the fluorescent film in an inner space of the tubular member, the cold cathode being formed with concavities and convexities on a surface facing the fluorescent film; and
an electron lead electrode for generating an electric field for pulling out electrons from the cold cathode.

7. The fluorescent lamp according to claim 6, wherein the electron lead electrode is formed on a surface of the fluorescent film.

8. The fluorescent lamp according to claim 6, wherein the electron lead electrode is formed between the tubular member and the fluorescent film.

9. The fluorescent lamp according to claim 6, wherein the electron lead electrode is formed on an outer circumferential surface of the tubular member.

10. The fluorescent lamp according to claim 9, wherein the electron lead electrode is made of conductive material and has a mesh shape, or is made of conductive material through which fluorescence emitted from the fluorescent film is transmitted.

11. A manufacture method for a fluorescent lamp comprising steps of:
forming a fluorescent film on a first surface of a first member, the first surface being defined on a surface of the first member and having an elongated shape;
assembling a cold cathode made of graphite on a second surface of a second member, the second surface being defined on a surface of the second member and having an elongated shape, a surface of the cold cathode being formed with concavities and convexities and facing a side opposite to the second member; and
disposing the first and second members with the first and second surfaces facing each other and spaced by a gap, closing sides and opposite ends to define a space surrounded by the first and second members, and evacuating the space.

12. A manufacture method for a fluorescent lamp comprising steps of:
forming a fluorescent film on an inner circumferential surface of a hollow tubular member which is open at least one end;
removing the fluorescent film in an elongated area along a longitudinal direction of the inner circumferential surface of the tubular member;
assembling a cold cathode made of graphite in an area where the fluorescent film was removed, a surface of the cold cathode being formed with concavities and convexities and facing the fluorescent film; and
closing the open end of the tubular member and evacuating an inner space.

13. The manufacture method for a fluorescent lamp according to claim 12, further comprising a step of forming a conductive film constituting an electron lead electrode on a surface of the fluorescent film, after the fluorescent film is formed and before the fluorescent film is removed, wherein in the step of removing the fluorescent film, the conductive film is also removed in the area where the fluorescent film is removed.
